(19) United States
(12) Patent Application Publication
(10) Pub. No.: US 2014/0083001 A1
(43) Pub. Date: Mar. 27, 2014

(54) PLANT PROTECTOR

(71) Applicant: Nicholas Alcov, Arroyo Grande, CA (US)

(72) Inventor: Nicholas Alcov, Arroyo Grande, CA (US)

(21) Appl. No.: 14/090,574

(22) Filed: Nov. 26, 2013

Related U.S. Application Data
(63) Continuation-in-part of application No. 12/925,549, filed on Oct. 25, 2010.

(51) Int. Cl. A01G 13/10

(52) U.S. Cl. CPC A01G 13/10; A01G 13/105
USPC 47/20.1

(57) ABSTRACT

An example plant protector includes a planar body having a top surface and a bottom surface defined within a major edge, a minor edge, a left edge and a right edge. A decorative pattern is formed on the planar body, and a plurality of highly reflective materials are configured for removable coupling to the planar body to reflect different wavelengths of light. The planar body surface is configured to assume a hollow, conical shape when portions of the top and bottom surfaces are overlapped at the left and right edges.

### CROSS REFERENCE TO RELATED APPLICATIONS

This application is a continuation-in-part of, and claims the priority benefit of U.S. patent application Ser. No. 12/925,549 filed Oct. 25, 2010 for “Eco-Safe Plant Protector,” incorporated by reference in its entirety as though fully set forth herein.

### BACKGROUND

While many forms of protection for plants are available, their use is subject to the acceptance of the consumer. Frequently this acceptance is dependent on the appearance of the apparatus presented. These pest deterrents are limited as to the type of pest that they deter. For example, a particular deterrent may deter snails, but not insects, and vice versa. Brucker, (U.S. Pat. No. 4,471,560) describes a series of copper plates to provide a snail barrier. However, the device does not attempt to present a decorative appearance, and use is limited to snails. In addition, deterrents may be effective at deterring pests, these typically do not enhance the growth of the plant (excluding the implied benefits of preventing damage cause by the pest).

### BRIEF DESCRIPTION OF THE DRAWINGS

FIG. 1 is a perspective view of an example plant protector illustrating an upper surface of a multi-lobed shape with a slit leading from the edge to a center opening.

FIG. 2 is a perspective view of an example plant protector illustrating an example means of maintaining its position once on the plant.

FIG. 3 is a perspective view of an example plant protector illustrating an example reflective holographic upper surface with a boundary of a material capable of maintaining and discharging an electrostatic charge.

FIG. 4 is a perspective view of an example plant protector illustrating a lower surface with copper foil over a center opening and an example means of attachment.

FIG. 5 is a perspective view of an example plant protector illustrating an upper surface with adhesive.

FIG. 6 is a perspective view showing two plants with example plant protectors illustrating the eco-safe plant protectors accommodating the shape of the foliage of the plants.

FIG. 7 is a perspective view of an example plant protector illustrating an upper surface in an un-rolled state.

FIG. 8 is a perspective view of a portion of a roll of an example plant protector illustrating perforations in the upper surface.

FIG. 9 is a top view of an example plant protector in a planar state.

FIG. 10 is a top view of an example plant protector in an expanded state having a hollow, frustoconical shape.

### DETAILED DESCRIPTION

A plant protector is disclosed herein which deters and/or kills a broad spectrum of pests. The plant protector may enhance the growth of plants, and can be used safely both indoors and outdoors while maintaining a pleasant appearance which will be accepted by the consumer. As such, the plant protector may be described as an “eco-safe” plant protector, although this is not intended to be limiting in any way. While the examples described herein are directed to apparatus which may repel and/or kill plant pests and increases the growth and yield by physical, rather than chemical means, the use of chemicals and or alternative methods may also be applied.

In an example, the plant protector provides an ecologically safe plant protector, which may repel snails as they attempt to climb over the surface. In addition, the example plant protector may repel aphids, whiteflies, leafhoppers and other pests, as they approach the plant. Crawling insects may be trapped on its surface.

In an example, the plant protector has a top surface, a bottom surface and an edge. Within the body is an opening which may be preferably centered. The opening may have a shape such as a star, daisy, circle, geometric or other shape. The outer edge may have a pleasant appearance such as, but not limited to a multi-lobed flower, a snowflake, a geometric shape or other shape having a repeating pattern around the perimeter. The bottom surface may have a material reflecting or emitting a color which does not attract insects. It should be noted that a silver bottom surface without the reflection of the sun will attract insects.

In an example, tinsel, streamers, or other extensions may protrude from the edge at various locations. A slit may be provided from the edge to the center opening. The stem, trunk, or branch of the plant may be passed along the slit of the plant protector to the center opening of the plant protector. The shape of the plant protector is such that as the edge along one side of the slit is positioned over the other side of the slit, a cone shape is achieved. The cone shape can be created with the larger opening facing upward or facing downward.

In an example, the shape of the foliage of the plant can be used to determine which cone shape is better suited for positioning on the plant. The shape of the plant protector is such that even as one edge at the slit is positioned over a portion of the other side of the slit, the general pleasant appearance of the plant protector may be retained.

In an example, the upper portion has a reflective surface, preferably mirror bright silver, which provides resistance to outdoor exposure of rain, wind, and/or other elements. The reflective material may be made of foil (e.g., aluminum and/or plastic, vinyl and the like), and/or may have a film (e.g., a holographic, biaxially-oriented polypropylene film or other such material) adhered to a surface to provide a reflective surface (e.g., a mirror bright silver reflective surface). Material such as glitter used to reflect or emit iridescence is also contemplated.

Before continuing, it is noted that as used herein, the terms “includes” and “including” mean, but is not limited to, “includes” or “including” and “includes at least” or “including at least.” The term “based on” means “based on” and “based at least in part on.”

It is also noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

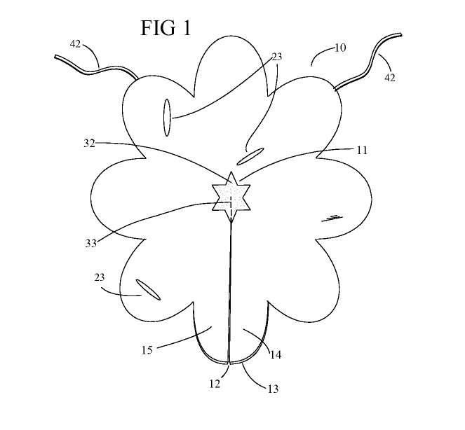

FIG. 1 illustrates a plant protector 10, the shape of which has a pleasant appearance such as multi-lobed flower shape. Stars, geometric shapes, a circle or other shapes, such as but not limited to snowflakes, may also be utilized. Tinsel or streamers 42 at various locations may be utilized. An opening 11 located at or near the center of the plant protector 10 may have a shape which aids in holding the opening against the plant.

While a circular shape may be utilized for the center opening, shapes which have irregularities such as a star which come in contact with the plant and can create a fold around the plant are better suited for holding the plant protector in place. A slit 12 from the edge 13 of the plant protector 10 to the opening 11 is utilized to position the plant protector 10 around a trunk, stem, or branch of the plant.

The repeating shape of the perimeter 13 of the plant protector 10 is such that when the surface 14 on one side of the slit 12 is positioned over the surface 15 on the other side of the slit 12, a semblance of the original shape is maintained or in other styles an illusionary transformational different pleasing shape is achieved. The action of moving the edges of the slit 12 over each other decreases the size of the opening 11, thus securing the plant protector 10 against the plant and creating a funnel like shape. Openings 23 may be provided throughout the surface to reduce wind resistance so that the plant protector does not get blown off on windy days.

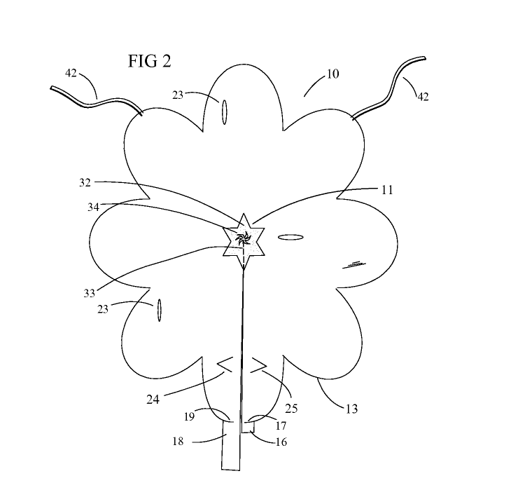

FIG. 2 illustrates the upper surface of the plant protector 10 showing an example means of maintaining the plant protector 10 in place once it has been positioned around the plant. In an example, the means of attachment can be achieved by using inserting cuts 24 on one side of slit 12, which fit into receiving cuts 25 on the other side of the slit 12 as the edges of the slit 12 are moved over each other. Another example means of attachment is to position a slit 17 of a short tab 16 into the slit 19 of long tab 18. Short tab 16 is then bent under. Long tab 18 is then bent under and over the bent short tab 16 and onto the bottom surface of the plant protector. These tabs can be kept in place by means such as double sided tape, glue, paper clip, staple and/or other holding means. Other means of maintaining the plant protector 10 onto the stem are contemplated.

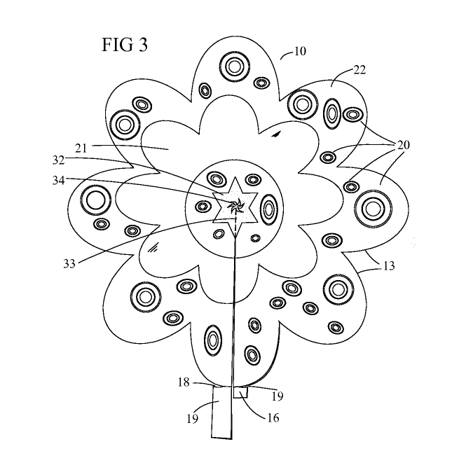

FIG. 3 illustrates a top surface of the plant protector 10 with a reflective holographic film with one of many possible patterns, such as the circles pattern 20 shown. The patterns may be of a specific color or provide iridescence. The background 22 may be a silver mirror finish. Positioned along the perimeter 13 of the top surface is a width of a material 21 capable of maintaining and discharging an electrostatic charge, which provides a barrier against snails and other pests from further movement up the plant. This barrier may be achieved with the use of copper, aluminum or other conductive material in a decorative pattern. The conductive material 21 may be adhered to the surface by means such as a conductive adhesive, double sided tape and the like, which maintains the electrical conductivity of the conductive material used to repel the snails. A more expensive example may use copper or aluminum or other conductive material as the surface base and adhere reflective silver foil or holographic film onto the areas of the conductive material. Copper repels snails and kills strains of bacteria, mold, fungus and other micro-organisms which can be detrimental to plants.

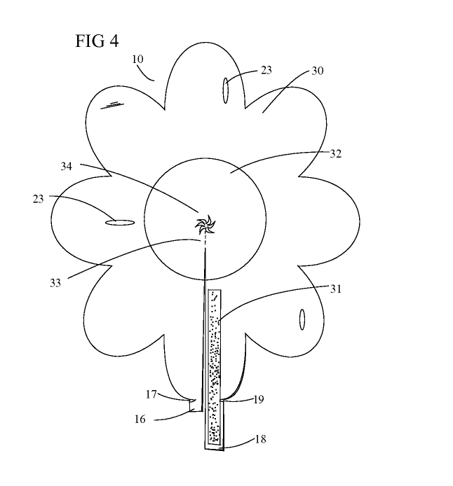

FIG. 4 illustrates a bottom surface 30 of the plant protector 10. Once the plant protector 10 is in position around the plant, the shorter tab 16 is inserted into the slit 19 of the longer tab 18. In an example, a protective non-stick strip (not shown) is removed from a strip of double sided tape 31 on the back of longer tab 18. Shorter tab 16 is bent under. Then longer tab 18 is bent under and on top of short tab 16. Then pressed against the bottom surface to hold the plant protector 10 in place, once the opening has been reduced to the size required to grip the plant. A paper clip, staple or other fastening means can also be utilized to assist in holding the two edges together.

While the example shown uses different sized tabs, the sizes and any differences in the tabs and their location on the plant protector 10 are provided for illustrative purposes only, and should not be construed as limiting in any manner. In addition means other than tabs such as a peel and stick adhesive along one slit to which the other edge can adhere are contemplated. A surface of copper 32 such as copper foil (e.g., larger than the center opening 11 shown in FIG. 3) may provide a barrier from pests climbing through the center opening.

A slit, perforation 33 or other means of allowing the passage of the plant toward the center of the plant protector past the copper foil can be utilized. An opening (e.g., the pin wheel shape 34 in the center of the copper foil) may aid in maintaining the position of the plant protector 10 on the plant. Other pointed and/or jagged shapes may also be utilized and achieved by means such as punches, cutting tools and the like. For larger stems the smaller opening 34 may not be needed.

In an example, the opening in the copper foil may be made smaller than the center opening to help hold the plant protector 10 in place. This may be particularly helpful for plants with a stem smaller than the opening of the upper surface. Adhesive on the copper foil is one means of aiding in securing the plant protector onto the plant. The copper foil folds around the plant yet keeps the opening somewhat closed against pests.

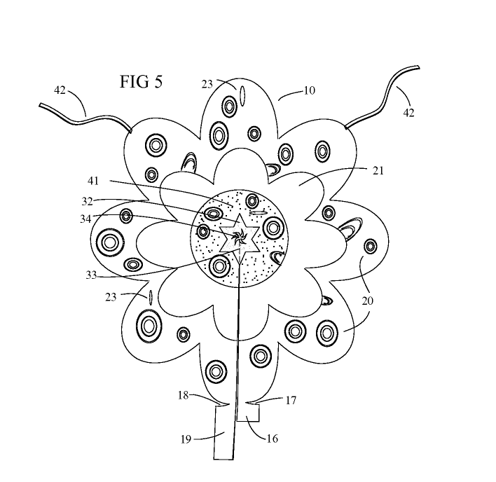

FIG. 5 illustrates the top surface of the plant protector 10 with a film of water resistant adhesive 41 around the center area. The adhesive is a type which remains tacky for extended periods of time. In an example, the adhesive 41 may be non-toxic and/or bio-degradable. Insects crawling up the plant from below the plant protector 10 are trapped by the adhesive. An attractant or bait at the location of the adhesive may be used to provide additional defense against pests.

Another example means of killing plant pests is food grade diatomaceous earth, which does so by a physical rather than chemical action. The diatomaceous earth may be applied on the surface of the plant protector 10. A means of securing the diatomaceous earth to the plant protector 10 may include a peal and stick covering over the adhesive 41, which when removed, exposes the diatomaceous earth to the pests. The diatomaceous earth may be dusted on top of the adhesive and/or other areas of the plant protector. A covering of non-stick material (e.g., a waxed paper) covering on the adhesive may be removed prior to use, to expose the adhesive, bait, and/or diatomaceous earth.

Other means of killing plant pests are also contemplated. While the illustration shows the adhesive on a location at the upper surface other locations such as on the lower surface or both may be utilized.

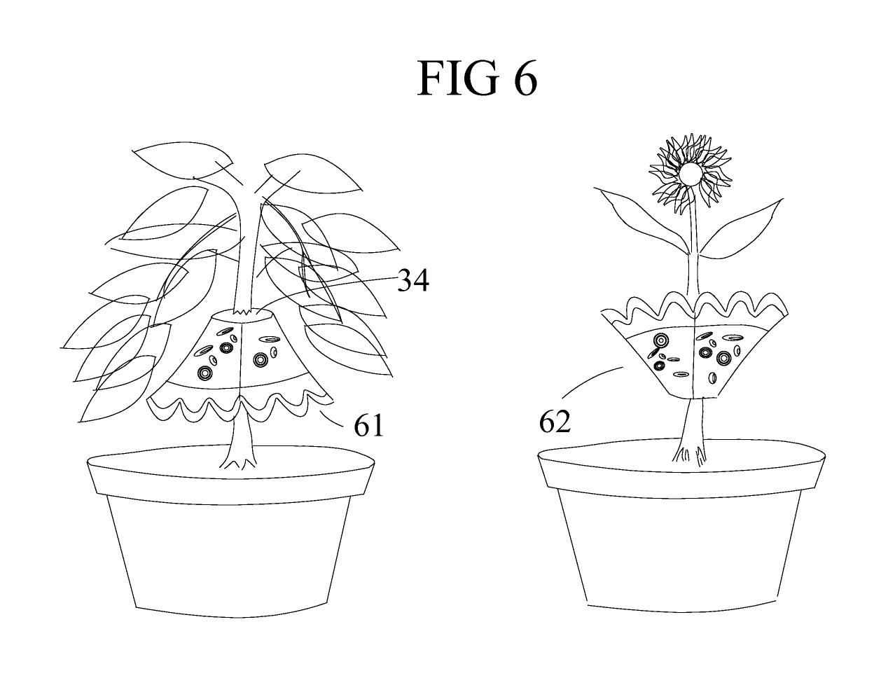

FIG. 6 illustrates as one side of the plant protector 10 is positioned over the other side, a funnel shape is created. By pushing upward with the fingertips on the bottom surface, while pushing downward on the edges of the top surface with the thumbs, as the sides of the slit are moved over each other, a funnel shape with the larger opening facing downward 62 is created. Reversing the pressures creates a funnel with the larger opening facing upward 61.

The shape of the foliage of the plant may be used for selecting or determining which shape to use. Frequently as in the case of vegetables, there may be instances where there is only a small distance between the soil and the foliage of the plant in which to form a barrier between snails, insects, other pests, and the leaves of the plant. The ability to choose the shape which best fits this small space provides an added benefit not provided by prior art.

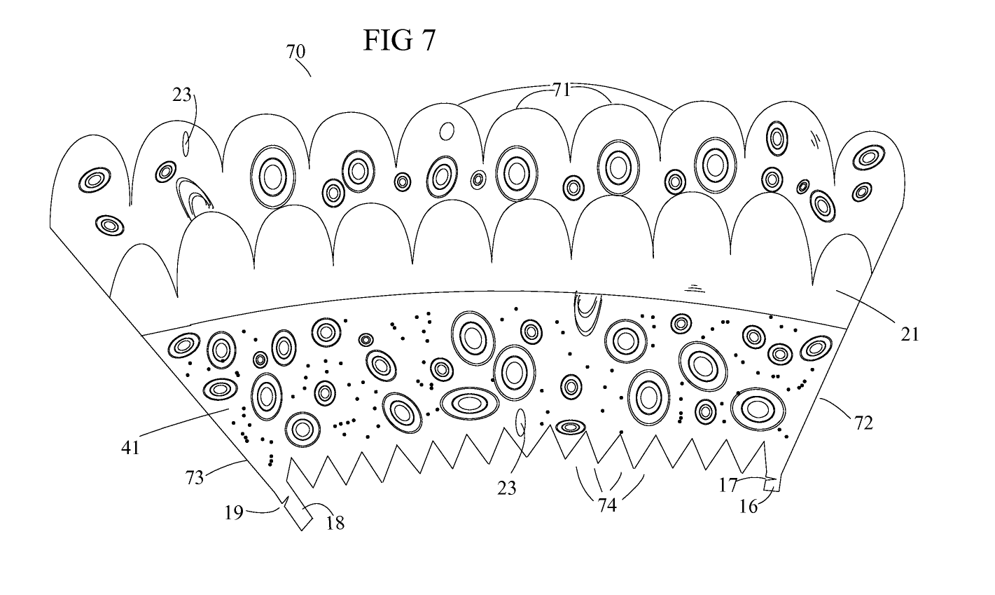

FIG. 7 illustrates a top surface 70 of an unrolled plant protector with highly reflective covering, with a scalloped edge 71. A material 21 capable of maintaining and discharging an electrostatic charge is shown attached such that when the edges 72 and 73 are overlapped, and attachment tabs 16 and 18 are connected at the slits 17 and 19 and overlapped, a continuous perimeter of conductive material is achieved. Jagged edge 74 may provide the center opening when edges 72 and 73 are overlapped. Foil or copper or other material is then attached over the center opening. As previously discussed, a smaller opening with an irregular shape (e.g., a pinwheel, star or the like) may be used if needed to help hold the plant protector on the stem. A slit or perforation to the center keeps the copper from tearing when attached to the stem. For thicker stems the smaller opening may not be needed.

Adhesive material 41 may be covered with a non-stick material (not shown), which can be readily removed after the plant protector is in position on the plant. Openings 23 throughout the surface may reduce wind resistance.

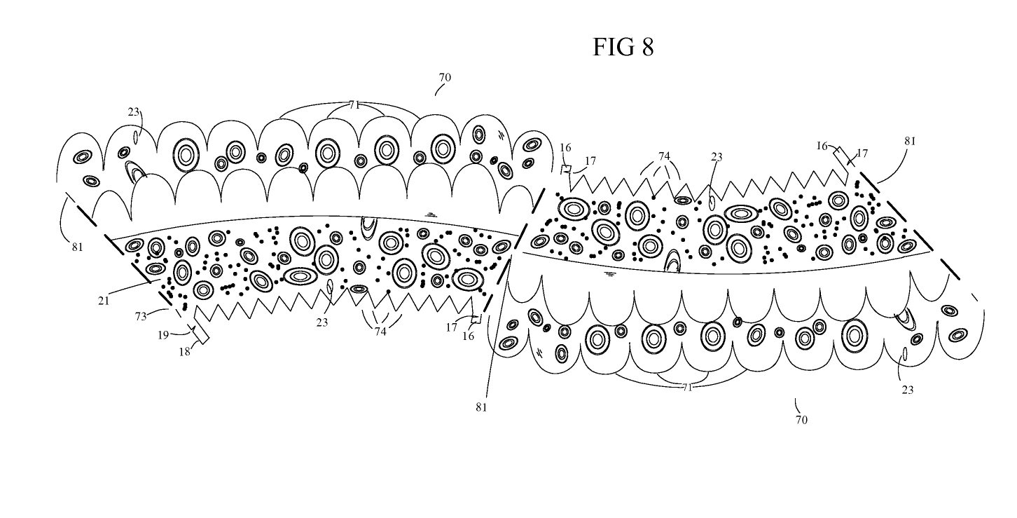

The roll of eco-safe plant protectors can be prepared. so that an individual plant protector is held in place next to another plant protector with a means such as a perforation 81, as illustrated in FIG. 8. This means allows easy removal from the remainder of the roll. Other means may include but are not limited to, adhesive tape, clips and the like.

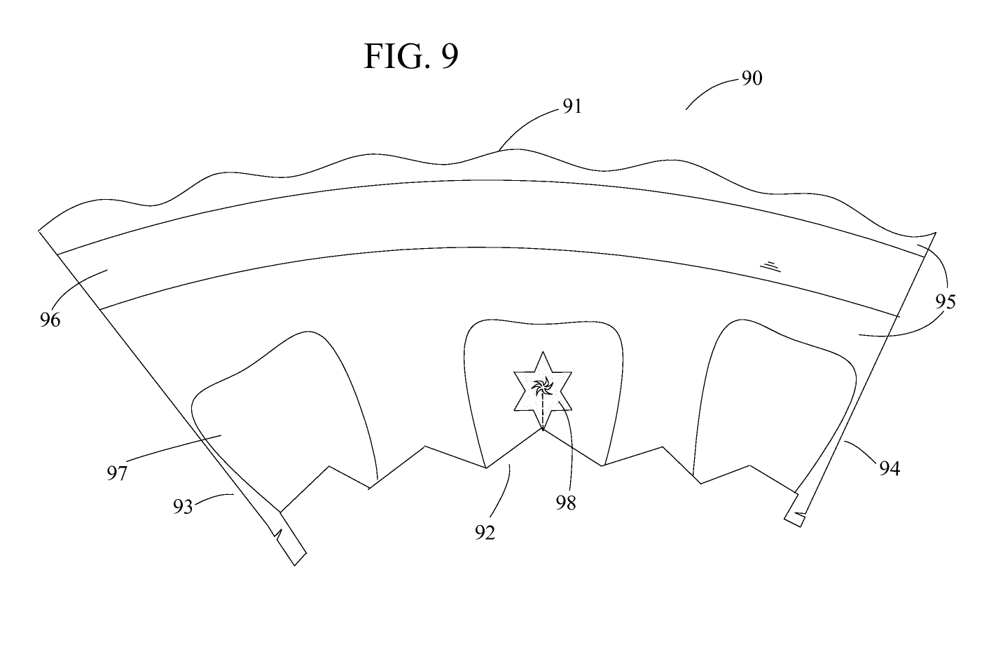

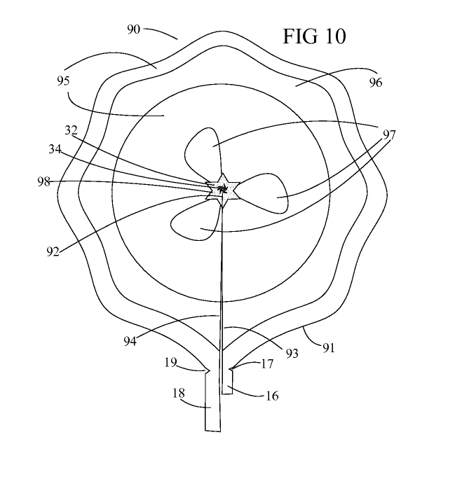

Referring to FIGS. 9 and 10, another example plant protector 90 is shown. The plant protector may also be attached at the base of the plant to increase initial growth. The plant protector 90 may be attached to higher branches of a tree or plant, e.g., to increase fruit production. The plant protector 90 may also be attached at both high and low positions on the plant.

The example plant protector 90 may include a planar body (FIG. 9) having a top surface and a bottom surface (not visible) defined within a major edge 91, a minor edge 92, a left edge 93 and a right edge 94. As discussed with reference to FIG. 8 above, the planar bodies may be provided to an end user in a roll such that the end user may roll out one or more of the planar bodies and separate them from the roll along the perforated regions. A decorative pattern may be formed on the planar body either at the top surface, the bottom surface or both.

In the expanded state (FIG. 10), electro-statically charged strip 96 provides a thin, foil loop applied to the hollow frustoconical body interior surface thereby forming a circumferential ring at or near the major edge 91 which provides a barrier against snails and other pests from further movement up the plant.

The upper surface 95 of plant protector 10, may reflect or emit a dark blue color to enhance the production of zucchini, squash, cucumbers, melons and other such plants. Thin, foil loop 96 may reflect or emit a mirror bright silver color to repel Thysanoptera and/or other pests which are attracted to dark blue.

While this example illustrates an upper surface 95 which reflects or emits a dark blue color, it is not intended to be limited to only this color. Other plants may obtain a greater benefit from a different color. For example, if the plant benefits from yellow, then upper surface 95 may be selected and provided to reflect or emit yellow light. However, if damaging Aphidoidea and/or other pests are attracted to yellow, then the mirror bright silver foil loop 96 may be used (e.g., to repel Aphidoidea and thus the virus which it transmits).

A thin, foil sheet 98 may be coupled with the hollow, frustoconical body at, and substantially covering the minor opening, to prevent the plant protector from slipping down stem. In some examples, this thin, foil sheet may be constructed from a copper material.

It should be noted that products which lay on the ground affect both the temperature and moisture at the roots, which may be detrimental to the plant. These ground based products produce a general, not specific plant response. These products also do not have the ability to both affect specific plant behavior of specific plants while also repelling pests. In addition it has been shown that the benefit from ground based products are limited to use with small short plants. The evidence is shown by their discontinued use by producers of taller crops.

The disclosure here has the ability to lay on the ground or be positioned on the plant where it will have more significant results.

As already described above, the planar body surface of the plant protector 90 may be configured to assume a hollow, conical (or frustoconical) body, for example, when portions of the top and bottom surfaces are overlapped at the left 93 and right 94 edges. In this expanded state (FIG. 10), the hollow, frustoconical body has an interior surface and an exterior surface defined between a major opening formed by major edge 91; and a minor opening formed by minor edge 92. The body may be generally shaped to accommodate the foliage of the plant with which it is intended to be used. When placed with the major opening or major edge 91 downward at or near the soil, in a so-called “umbrella” configuration, the plant protector 90 without the previously discussed openings 23, may be configured to speed up seed germination.

In an example, a light permeable material 97, such as, for example, a translucent or transparent plastic sheet may be included with or formed as a part of the planar body (FIG. 9).

In an example, the planar body surface of the plant protector 90 may be a light permeable material which reflects or emits a specific color.

The plant protector 90 may include one or more highly reflective material(s) 95. In an example, highly reflective material(s) 95 are configured for removable coupling to the planar body. The highly reflective material(s) 95 may be selected and configured to reflect different wavelengths of light. In an example, highly reflective material(s) 95 are removable from plant protector 90 for replacement with alternative reflective materials. As such, while the plant protector 90 is in use, a user may choose to replace a highly reflective material reflecting a particular range of wavelengths, with other highly reflective material(s) reflecting a different range of wavelengths, e.g., to repel different pest(s) or affect plant function.

Highly reflective material(s) 95 may be selected and arranged to reflect one or more particular wavelength (or range of wavelengths) of light, for example configured to attract pollinators for a particular plant variety. In an example, highly reflective material(s) 95 are configured to reflect a number of sharply contrasting colors of light to encourage pollination by bees, in particular. As such, example plant protectors elicit a specific response. By selecting a combination of colors that are reflected by reflective materials 95, a desired function of the plant can be achieved and specific pests or groups of pests that plague the concerned variety of plant can be repelled. For example, for purposes of illustration, bees are drawn to a specific wavelength of light that may be reflected by flowers which are entomophilous. Hummingbirds are drawn to a specific wavelength reflected by flowers which are ornithophilous. The trichromacy of bees have peaks at about 340 nm (near ultra-violet), about 430 nm (violet-indigo) and about 540 nm (yellow green).

As such, bees may have difficulty distinguishing red flowers from green foliage. The contrast of colors within the flower, differentiate the flower from the foliage. Providing the body 95 in an ivory color with lobes 97 in an approximate range from 300 nm to 400 nm provides a plant protector with contrasting wavelength, common to many entomophilous flowers.

These examples should not be limiting since specific families of bees are attracted to an even more specific range of colors. Birds with tetrachromacy have an additional peak at about 565 (yellow) The yellow cone cell receptors can still be stimulated by red at about 650 nm near the peak. Thus the receptors of birds peak at the yellow range, and they can distinguish flowers in the red spectrum. Contrasting colors may not be as important for birds as for bees, thereby directing color choices for the plant protector.

In an example, highly reflective material(s) 95 are provided by mirror bright silver. However, other materials may also be used.

In an example, the highly reflective material(s) 95 may be configured to reflect light of wavelengths between about 430 nm and 490 nm. These wavelengths may be selected to provide an increase in the production of cucumber, zucchini, melons and other plants.

In another example, the highly reflective material(s) 95 may be configured to reflect light of wavelengths between about 490 nm and 560 nm.

In another example, the highly reflective material(s) 95 may be configured to reflect light of wavelengths between about 650 nm and 700 nm. These wavelengths may be selected to increase budding and flowering of plants, such as but not limited to tomato plants.

In another example, the highly reflective material(s) 95 may be configured to reflect light of wavelengths of about 550 nm.

In addition to repelling pests on the interior surface, highly reflective material(s) 95 may be arranged to reflect light of a wavelength selected and configured to increase vegetative growth of a plant to increase the plant height with fewer lower leaves. As an example grapevines produce canes for attachment to the trellis wires earlier. Nutrients, water and the plants energy are economically utilized for fruit production. It should be noted that reflective silver affects general plant growth and not the specific growth discussed which limits production of lower foliage.

The highly reflective materials 95 may also be selected and arranged to reflect light of a wavelength (or range of wavelengths) configured to increase budding and flowering of a particular plant variety.

A material reflecting or emitting an insect repelling color may also be applied to the bottom surface of the plant protector. For example, a black or white material may be provided such that crawling insects are not attracted.

Also in the interest of deterring pests, an electro-statically charged strip 96 may be applied to the planar body. The electro-statically charged strip 96 may be provided at one or more of the major edge, the minor edge, the left edge or the right edge 91, 92, 93 and 94 to form a boundary against pests. In another example, the electro-statically charged strip 96 may be applied between left edge 93 and right edge 94, and may have a width effective to prevent snails and slugs from crossing thereover.

While the electro-statically charged strip 96 may be any of a variety dimensions, in an example, electro-statically charged strip 96, to be effective against snails and slugs, would have a width greater than 20 mm. Electro-statically charged strip 96 may also be selected and configured to release metallic ions toxic to bacteria, fungus, and micro-organisms. Example materials for providing the electro-statically charged strip include but are not limited to copper and conductive aluminum.

While the foregoing description discusses growth enhancement as the result of the reflective properties and wavelengths of the surface material, other means (e.g., impregnating a component of the plant protector with a fertilizer or pesticide such that when it comes in contact with water, a predetermined amount is released) may also provide benefit to the plant. Other means of enhancing the plant can also be incorporated into the plant protector 10.

The foregoing description of the embodiments of the invention has been presented for the purposes of illustration and description. It is not intended to be exhaustive or limiting to the precise form disclosed. Many modifications and variations are possible in light of this disclosure. It is intended that the scope of the invention be limited not by this detailed description, but rather by the claims appended hereto.

1. A plant protector comprising:
an interior surface and an exterior surface defined between major and minor openings;
a highly reflective material applied to the interior surface;
a thin, conductive foil loop applied to the interior surface;
a thin, foil sheet coupled at the minor opening; and
a bottom surface comprising a material reflecting or emitting a color which does not attract insects.

2. The plant protector of claim 1, wherein the highly reflective material is selected and arranged to reflect a wavelength of light configured to attract pollinators for a particular plant variety.

3. The plant protector of claim 1, wherein the highly reflective material is selected and arranged to reflect light of a wavelength configured to increase budding and flowering of a particular plant variety.

4. The plant protector of claim 1, wherein the highly reflective surface is selected and arranged to reflect light of a wavelength configured to increase vegetative growth of a plant to increase the plant height at the expense of lower foliage.

5. The plant protector of claim 1, further comprising a light-permeable material.

6. An eco-safe plant protector, comprising:
a planar body having a top surface and a bottom surface defined within a major edge, a minor edge, a left edge and a right edge;
a decorative pattern formed when the planar body is attached to a plant;
a plurality of highly reflective materials configured for removable coupling to the planar body to reflect different wavelengths of light; and
wherein the planar body is configured to assume a hollow, conical shape when portions of the top and bottom surfaces are overlapped at the left and right edges, with a bottom surface comprising a material reflecting or emitting a color which does not attract insects.

7. The eco-safe plant protector of claim 6, further comprising a copper material coupled to the planar body at the minor edge, and wherein the copper material is configured to cover a hole formed by the minor edge when the planar body surface has assumed the conical shape.

8. The eco-safe plant protector of claim 6, wherein at least one of the plurality of highly reflective materials is selected and configured on the planar body to reflect light of wavelengths between about 430 nm and 490 nm.

9. The eco-safe plant protector of claim 6, wherein at least one of the plurality of highly reflective materials is selected and configured on the planar body to reflect light of wavelengths between about 490 nm and 560 nm.

10. The eco-safe plant protector of claim 6, wherein at least one of the plurality of highly reflective materials is selected and configured on the planar body to reflect light of wavelengths between about 650 nm and 700 nm.

11. The eco-safe plant protector of claim 6, wherein the plurality of highly reflective materials are selected and configured on the planar body to reflect a number of contrasting colors of light.

12. The plant protector of 6, further comprising an electro-statically charged strip applied to the planar body between the left and right edges, wherein the electro-statically charged strip forms a circumferential ring intermediate to the major and minor edges when the planar body surface has assumed the frustoconical shape, wherein the electro-statically charged strip has a width effective to prevent snails and slugs from crossing thereover.

13. An eco-safe plant protector comprising:
a body having a top, a bottom and an outer edge, with an opening at or near a center of the body, with a slit from the outer edge of the body to the center of the opening, the body having a decorative shape pattern selected such that when two edges created by the slit are overlapped, the decorative shape is retained;
wherein the top of the body has a highly reflective color selected to increase plant growth and to repeal pests;
wherein the bottom of the body has a color selected to not attract insets,
a copper material is applied over the opening on the bottom of the body; and
a material configured to discharge an electrostatic charge applied to form a boundary around a perimeter of the body with a means of attachment.

14. The eco-safe plant protector of claim 13, wherein a non-chemical pest deterrent is applied to the body.

15. The eco-safe plant protector of claim 13, further comprising a plurality of bodies in a roll, wherein individual plant protector bodies are separable from one another in the roll.

16. The eco-safe plant protector of claim 13, wherein the body is shaped to accommodate foliage of a plant.

17. The eco-safe plant protector of claim 13, further comprising tinsel, streamers, or other plurality of extensions.

18. The eco-safe plant protector of claim 13, further comprising a reflective holographic film on the body.

19. The eco-safe plant protector of claim 13, further comprising a material configured to reflect or emit iridescence.

20. The eco-safe plant protector of claim 13, wherein the body is shaped as a multi-lobed flower, a snowflake, or other shape having a repeating pattern about a perimeter of the body.
